(19) United States
(12) Patent Application Publication
(10) Pub. No.: US 2007/0189931 A1
(43) Pub. Date: Aug. 16, 2007

(54) Capacitively controlled field effect transistor gas sensor comprising a hydrophobic layer

(75) Inventors: Jurgen Ruhe, Eichstetten (DE); J.D. Jeyaprakash S. Samuel, San Jose, CA (US); Heinz-Peter Frerichs, St. Peter (DE); Mirko Lehmann, Frieburg (DE)

Correspondence Address: THE WEBB LAW FIRM, P.C., 700 KOPPERS BUILDING, 436 SEVENTH AVENUE, PITTSBURGH, PA, 15219, US

(73) Assignee: Micronas GmbH, Freiburg i.Br. (DE)

(21) Appl. No.: 10/566,412

(22) PCT Filed: Jul. 24, 2004
(86) PCT No.: PCT/EP04/08309

§ 371 Date: Jan. 3, 2007

(30) Foreign Application Priority Data
Jul. 30, 2003 (DE) 103 35 163.9

(51) Int. Cl. G01N 30/96

(52) U.S. Cl. 422/88

(57) ABSTRACT

The invention relates to a gas sensor comprising a substrate of a first charge carrier type whereon a drain and a source of a second charge carrier type are arranged. A channel area is formed between the drain and the source. The gas sensor also comprises a gas sensitive layer comprising poles between which a gas induced voltage is produced according to the concentration of a gas which is in contact with the layer. In order to measure said voltage, a pole of the gas sensitive layer is capacitatively coupled to the channel area by means of an air gap and the other pole is connected to a counter-electrode having a reference potential. A hydrophobic layer is arranged on the surface of the gas sensor between the gas sensitive layer and the channel area and/or on a sensor electrode which is connected to a gate electrode arranged on the channel area.

The invention relates to a gas sensor comprising a substrate of a first charge carrier type whereon a drain and a source of a second charge carrier type are arranged, wherein a channel area is formed between the drain and the source, and also comprising a gas sensitive layer comprising poles between which a gas induced voltage is produced according to the concentration of a gas which is in contact with the layer, wherein the gas sensitive layer for measuring the voltage is capacitatively coupled to the channel area by one of its poles over an air gap and to a counter-electrode having a reference potential by its other pole.

Such a gas sensor is disclosed in DE 43 33 875 C2. It has a gas sensitive layer that reacts to the effects of gasses with a change of its work function. There is an electrically insulating layer arranged in the channel area of the gas sensor, which covers the substrate and the source and drain areas. An air gap is formed between the channel insulation and the gas sensitive layer. This is in accordance with the suspended gate field effect transistor (SGFET) principle. The voltage induced in the gas sensitive layer by the presence of the gas capacitatively couples to the channel surface over the air gap and induces charges in the SGFET structure. The channel area is surrounded by a guard electrode that screens the channel area from electric potentials that are arranged outside of the gas sensor surface area defined by the guard electrode. However, the disadvantage of the gas sensor lies therein that the SGFET measuring signal is not only dependent on the concentration of the gas to be measured but also on the electric resistance between the guard ring and the channel zone, which is influenced by humidity. Disadvantageous above all is that for gradual changes in gas concentration, the measuring accuracy of the gas sensor decreases disproportionately to increasing moisture content.

An improved gas sensor has already been disclosed in DE 101 18 367 C2, in which there is a surface profiling having elevations and depressions formed between the guard ring and the channel area. By means of this relatively simply and economically achieved method, the distance between the guard ring and the channel area is increased, consequently reducing the Faraday current flowing between the guard ring and the channel. Although said gas sensor has proven its efficacy in practice in a wide range of applications, it nevertheless has disadvantages. The measuring accuracy of said gas sensor for gradual changes in gas concentration also decreases disproportionately to increasing moisture content.

Another gas sensor of the type mentioned in the introduction is disclosed in EP 1 191 332 A1, which sensor comprises a moisture sensitive layer in the same field effect transistor in addition to the gas sensitive layer, and wherein said moisture sensitive layer can be activated according to the same measuring principle as the gas sensitive layer. According to the disclosure statement, it is thereby possible, at a known temperature, to define moisture influences in comparison with the gas reaction to be measured, and to reduce the cross-sensitivity to moisture in the gas sensor by drawing on the moisture measuring signal. A disadvantage, however, lies therein that a complex and expensive compensation switch mechanism is also required, in addition to the additional moisture sensor. An additional disadvantage lies therein that such compensation is only valid for a specific temperature at a given time; therefore, in the event of temperature fluctuations, a temperature measuring signal must also be detected and taken into consideration.

The objective of the invention is therefore to create a gas sensor of the type mentioned in the introduction that enables a high degree of measurement accuracy and has a simple and compact construction. In doing so, the measurement accuracy should be largely independent of moisture influences.

This objective is solved in that there is a hydrophobic layer arranged on the surface of the gas sensor between the gas sensitive layer and the channel area and/or on a sensor electrode that is electrically connected to a gate electrode arranged on the channel area.

The adsorption of moisture on the surface of the gas sensor is impeded or even prevented completely in an advantageous manner by means of this surprisingly simple solution. By this means, ion transport between the channel area or the sensor electrode and areas of the gas sensor separated therefrom having a different electric potential than said channel area or sensor electrode, especially with a gas having high moisture content, is substantially limited. The measuring accuracy of the gas sensor thus remains largely constant even if the moisture content of the gas changes. Furthermore, high long term stability of the measurement accuracy is realized. The hydrophobic layer is advantageously arranged on an electrically non-conductive or semi-conductive layer. However, it is also conceivable to arrange the hydrophobic layer on an electrically conductive layer if the electrically conductive layer is electrically insulated from the channel area, the sensor electrode and/or another area separated from the electrically conductive layer, the potential of which differs from that of the electrically conductive layer. The hydrophobic layer is preferably constructed as an ultra-hydrophobic layer.

In a preferred embodiment of the invention, the gas sensor has an electrically conductive guard ring on its surface, which delimits the channel area and/or the sensor electrode from the channel area and/or the sensor electrode through a space, wherein the hydrophobic layer is arranged in at least one area of the gas sensor located between the guard ring and the channel area and/or the sensor electrode. By means of the guard ring, the potential over the channel area or the potential of the sensor electrode is prevented from being drawn after a specific time by the conductivity still remaining on the gas sensor surface to the potential of the pole of the gas sensitive layer, which is capacitatively coupled to the channel area, or to the potential of the guard ring. A potential drift is avoided by this means and an even greater accuracy of measurement is achieved.

In a functional embodiment of the invention, the hydrophobic layer extends continuously over the channel area and/or the sensor electrode. The gas sensor is then especially easy and economical to produce, as the hydrophobic layer can be superimposed to cover the entire surface of the gas sensor and in doing so a masking step can be eliminated.

It is advantageous if the hydrophobic layer is separated from the channel area and/or the sensor electrode and if it delimits the channel area and/or the sensor electrode, preferably in a ring- or frame-like manner. By this means, in a hydrophobic layer in which an interference voltage is induced by contact with an interfering gas different from that to which the gas sensitive layer is sensitive, the influence of said interference voltage on the measuring signal, and consequently the cross-sensitivity of the gas sensor to the interfering gas, can be reduced.

In a preferred embodiment of the invention, the static contact angle of the hydrophobic layer measured by water obtained on a planar surface measures is at least 70°, if necessary at least 90°, especially at least 105° and preferably at least 120°. Above all, with a contact angle of at least 120°, it is possible to achieve an especially high measuring accuracy of the gas sensor that is largely independent of the moisture content of the gas. The contact angle can be defined by using known standard measurement methods at room temperature.

In a functional embodiment of the invention, molecules of the hydrophobic layer are covalently bound to the surface of an adjacent, preferably semi-conducting or electrically insulating layer of the gas sensor. By this means it is possible to attach the hydrophobic layer directly to the adjacent layer of the gas sensor when manufacturing the gas sensor.

It is advantageous if the hydrophobic layer contains at least one polymer. The hydrophobic layer may then be superimposed on the surface of the gas sensor during the manufacturing of the gas sensor at room temperature, thereby protecting the implantation area and structures already present on the substrate from heat.

It is especially advantageous if the polymer is a fluoride and preferably a perfluoride polymer. A high level of accuracy in measuring the gas concentration can still be achieved by means of the strongly electronegative CF groups contained in said polymers, even when the gas to be measured has a high moisture percentage, e.g., a relative humidity of 90%.

In another advantageous embodiment of the invention, the polymer is connected to an adjacent, preferably semi-conducting or electrically insulating layer of the gas sensor by means of an intermediate layer preferably in the form of a monolayer, wherein the intermediate layer has at least one reactive group anchored on the adjacent layer, and wherein the polymer is preferably coupled to the intermediate layer by means of a covalent bond. In doing so, it is even possible when manufacturing the gas sensor to first superimpose the hydrophobic polymer on the intermediate layer so that it covers it completely, and then to photochemically bind it to the intermediate layer only in specific subzones of the surface of the gas sensor under the influence of an optical ray projected on the surface of the gas sensor by means of a shadow mask. The hydrophobic polymer can then be removed from the remaining subzones, for example, by washing the surface of the gas sensor. By means of this entire procedure, a gas sensor is produced comprising a structured hydrophobic layer arranged only on specific sites of its surface.

It is advantageous if the hydrophobic layer has a surface profiling with projections and depressions. Even greater measurement accuracy can be achieved thereby.

The depressions are preferably constructed as grooves or slots forming a frame or a ring around the channel area and/or the sensor electrode.

In the following, exemplary embodiments of the invention are explained in more detail, with reference to the drawings. Some parts are shown in a very diagrammatic context:

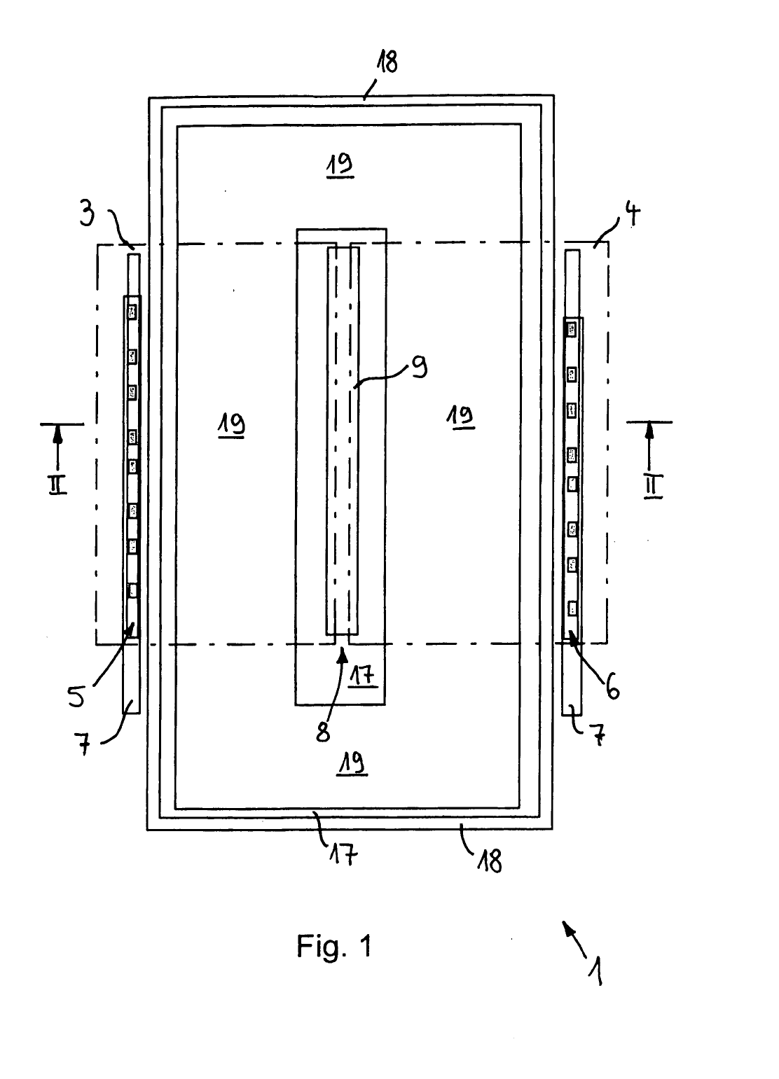

FIG. 1 shows a lengthwise section of a gas sensor, which has an ISFET located under a gas-sensitive layer represented by a dashed line,

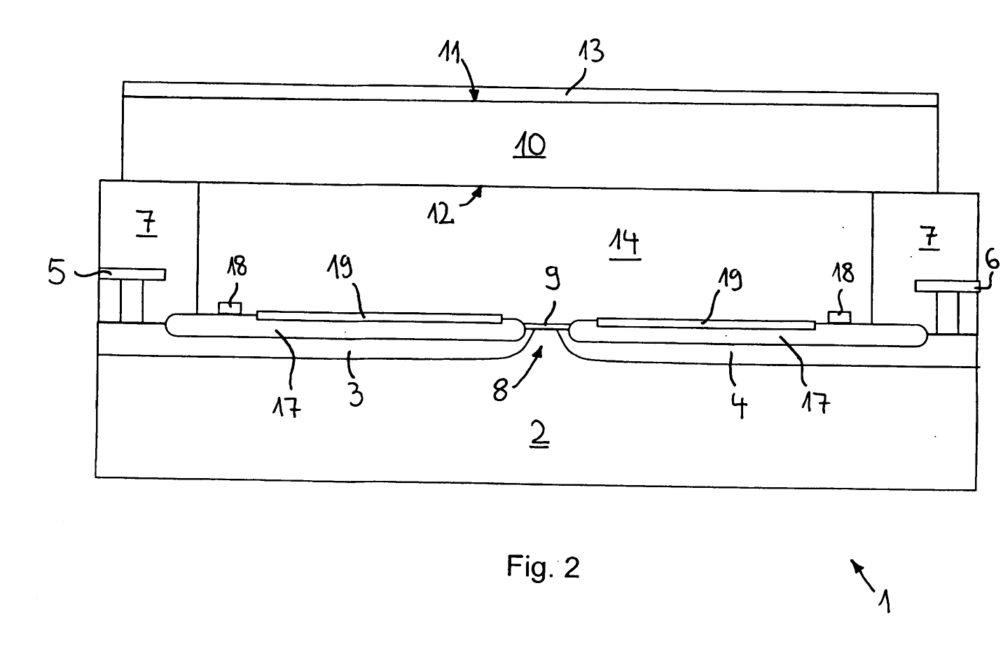

FIG. 2 shows a cross section of the gas sensor shown in FIG. 1 along the line of intersection designated by 11 in FIG. 1,

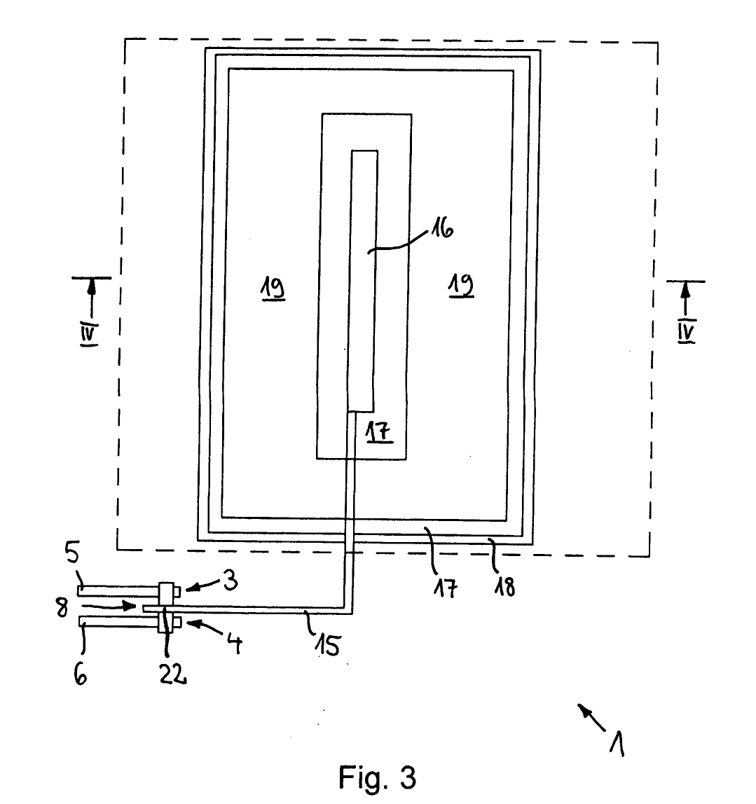

FIG. 3 shows a lengthwise section of a gas sensor, which has a CCFET, located under a gas-sensitive layer represented by a dashed line,

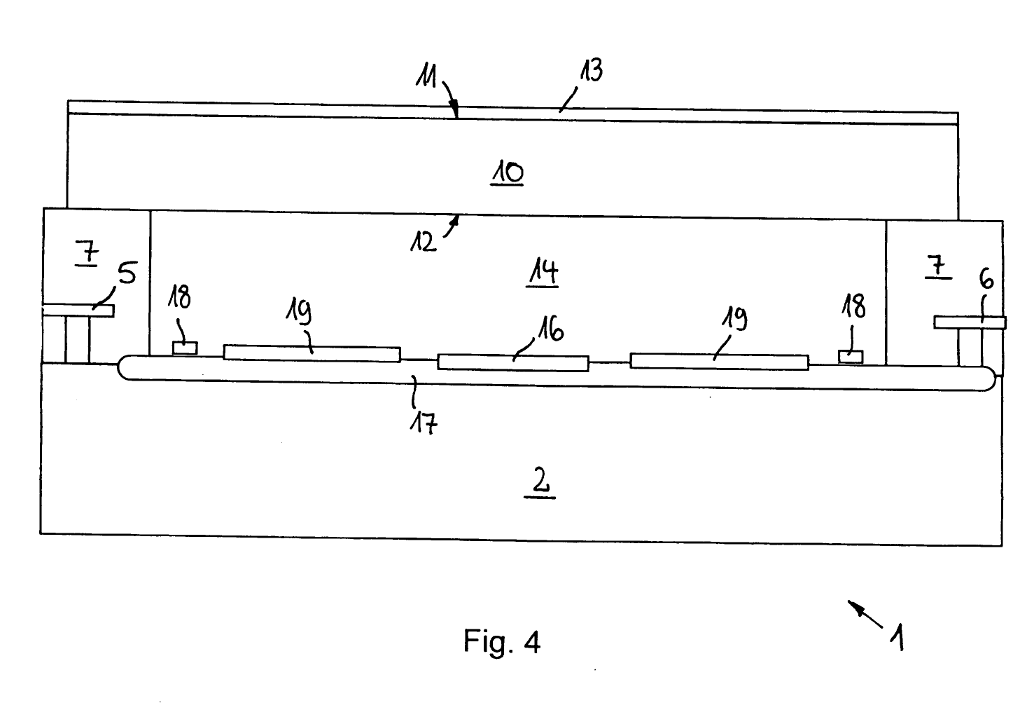

FIG. 4 shows a cross section of the gas sensor shown in FIG. 3 along the line of intersection designated by IV in FIG. 3,

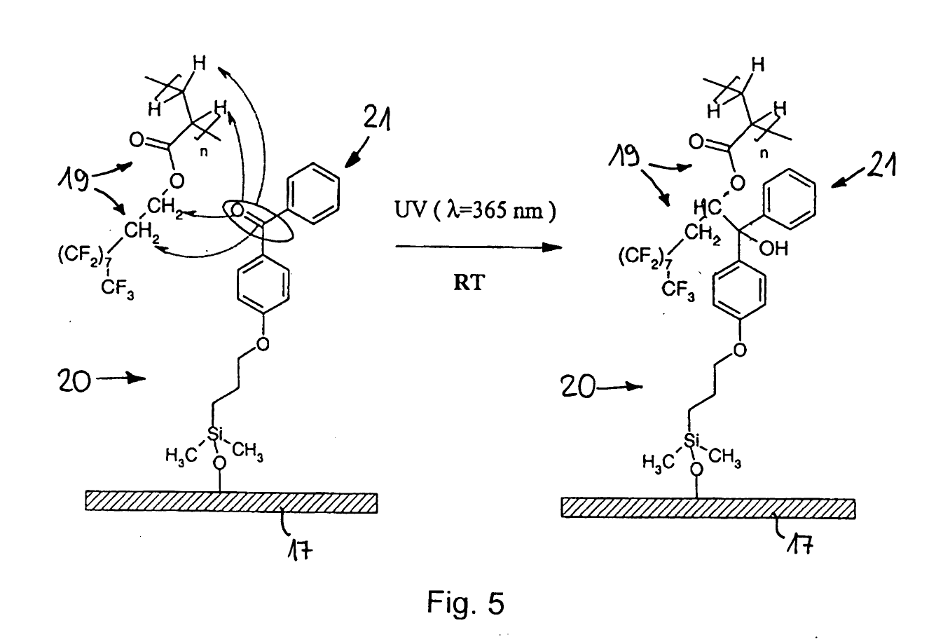

FIG. 5 shows a schematic illustration of the photochemical bonding of a hydrophobic polymer to a layer with linker molecules immobilized on an electrical insulation layer.

A gas sensor designated in its entirety by 1 has a substrate 2 of a first charge carrier type that may be composed, e.g., of p-type silicon. A drain 3 and a source 4 of a second charge carrier type are arranged on the substrate 2. The drain 3 and the source 4 may be composed, for example, of n-type silicon. The drain 3 is connected to a drain connector 5 by means of electric conductor paths that are only partially illustrated in the drawing. The source 4 is connected to a source connector 6 in like manner. The drain connector 5 and the source connector 6 are each arranged on a layer 7 deposited on the substrate 2.

In an exemplary embodiment of FIG. 1 and FIG. 2, there is a channel formed in the substrate 2 between the drain 3 and the source 4 whereon a thin oxide electric insulation layer 9 is arranged which serves as a gate dielectric. The thin oxide layer 9 is ca. 3-150 nm thick.

As can be discerned especially easily in FIG. 2, the gas sensor 1 also has a gas sensitive layer 10, and on the flat sides turned away from each other thereof there are poles 11 and 12 between which a gas-induced electrical voltage is produced according to the concentration of a gas in contact with the layer 10. For the detection of the voltage, the gas sensitive layer 10 is capacitatively coupled to the channel area 8 by one of its poles 12 over an air gap 14. The other pole 11 is connected to a counter-electrode 13 whereon there lies an electric reference potential. The air gap 14 has an access to the gas to be detected and is between the deposited layers 7, whereon the gas sensitive layer 10 rests.

In the exemplary embodiment of FIG. 1 and FIG. 2, the channel area 8 is openly constructed (ISFET) and capacitatively coupled directly to the gas sensitive layer 10 over the thin layer oxide and the air gap 14. It can clearly be discerned that the channel area 8 is arranged on the side of the air gap 14 that lies opposite the gas sensitive layer 10.

In an exemplary embodiment according to FIG. 3 and FIG. 4, the channel area 8 is arranged alongside of the gas sensitive layer 10 in the substrate 2 and covered with a gate electrode 22. For the capacitative coupling of the channel area 8 to the gas sensitive layer 10, the gate electrode 22 is connected by means of a conductor path 15 to a sensor electrode 16, which is arranged on an insulation layer 17 located on the substrate 2 on the side of the air gap 14 lying opposite to the pole 12 of the gas sensitive layer 10. The insulation layer 17 may be, for example, a SiO₂ layer.

Furthermore, the gas sensor 1 has an electrically conductive guard ring 18 on its surface, which delimits the channel area 8 in the exemplary embodiment according to FIG. 1 and FIG. 2 and the sensor electrode 16 leading to the channel area 8 in the exemplary embodiment according to FIG. 3 and FIG. 4. A space is provided thereby between the guard ring 18 and the channel area 8 of the exemplary embodiment according to FIG. 1 and FIG. 2 and between the guard ring 18 and the sensor electrode 16 of the exemplary embodiment according to FIG. 3 and FIG. 4. The guard ring 18 lies on a defined electric potential in order to screen the channel area 8 from electric potentials located outside of the surface zone of the gas sensor substrate 2 defined by the guard ring 18.

In the exemplary embodiment according to FIG. 1 and FIG. 2, a hydrophobic layer 19 is arranged between the guard ring 18 and the channel area 8 on the surface of the gas sensor 1. Said layer is located on an electric insulation layer 17, which is arranged on the drain 3, the source 4 and the areas of the substrate 2 located outside of the channel area 8. It can be discerned in FIG. 1 that the hydrophobic layer 19 delimits the channel area 8 in a frame-like manner and ends at a distance from the channel area 8 and the guard ring 18. By means of the hydrophobic layer 19, the adsorption of the water contained in the gas is substantially impeded in the part of the gas sensor surface located between the guard ring 18 and the channel area 8. By this means it is possible to attain a high level of electrical resistance on the surface and a high level of measurement accuracy of the gas sensor.

In the exemplary embodiment according to FIG. 3 and FIG. 4, the hydrophobic layer 19 is arranged on the insulation layer 17 between the guard ring 18 and the sensor electrode 16. In FIG. 4 it can be discerned that the hydrophobic layer 19 delimits the sensor electrode 16 in a frame-like manner and ends at a distance from the sensor electrode 16 and the guard ring 18. By means of the hydrophobic layer 19, the adsorption of the water contained in the gas is substantially impeded in the part of the surface of the gas sensor 1 located between the guard ring 18 and the sensor electrode 16.

The hydrophobic layer consists of a polymer, preferably made of poly(heptadecafluoroacrylate). In the manufacturing of the gas sensor 1, the hydrophobic layer 19 is attached to the insulation layer 17 by means of an intermediate layer 20. In order to do this, the intermediate layer 20 in the form of a benzophenone-functionalized silicon monochloride monolayer is first superimposed on the insulation layer 17. In FIG. 5 it can be discerned that upon exposure to UV light, free radicals are produced in the intermediate layer 20, which bind on contact to the insulation layer 17 and in doing so attach the intermediate layer 20 to the insulation layer 17.

Afterwards, a thin film of poly(heptadecafluoroacrylate) is deposited on the intermediate layer 20 so that it covers it entirely. Then the zones whereon the hydrophobic layer 19 is to be supported at a later time are irradiated with UV rays with the aid of a shadow mask. It can be discerned in FIG. 5 that the intermediate layer 20 has a photoreactive benzophenone group 21 which binds to an adjacent polymer of the future hydrophobic layer 19 when irradiated with UV light. In doing so, the benzophenone group 21 accepts a hydrogen atom from the adjacent polymer in such a way that a covalent bond is formed between the benzophenone group 21 and the adjacent polymer (see Prucker, O., Rühe, J. et al, Photochemical Attachment of Polymer Films to Solid Surfaces via Monolayers of Benzophenone Derivates, J. Am. Chem. Soc. (1999), 121, p. 8766-8770).

After the polymer of the hydrophobic layer 19 is bound in specific zones to the surface of the insulation layer 17 in this manner, the non-bound polymers for forming the structured hydrophobic layer 19 remaining on the non-irradiated zones of the surface are removed, for example, by washing them away with a solvent.

It should still be mentioned that there are also other possible exemplary embodiments wherein the hydrophobic layer 19 may extend without interruptions over the channel area 8, the sensor electrode 16 and/or the guard ring 18. In the production of such a gas sensor 1, the hydrophobic layer 19 may also be deposited directly on the insulation layer 17. This may be accomplished by precipitating hydrophobic trichloro(1H,1H,2H,2H-perfluorooctyl)silicate (TPFS) from the gas phase at a temperature of ca. 100° C. onto the insulation layer 17. TPFS is preferably precipitated in the absence of moisture so that cross-connections and inhomogeneities in the TPFS film precipitated on the surface are avoided. Furthermore, care must be taken to prevent dust particles from adhering to the surface during the precipitation process.

1. A gas sensor comprising a substrate of a first charge carrier type, whereon a drain and a source of a second charge carrier type are arranged, wherein a channel area is formed between the drains and the source, and with a gas-sensitive layer comprising poles between which a gas-induced voltage is produced according to the concentration of a gas which is in contact with the layer, wherein in order to measure the voltage, the gas-sensitive layer is capacitatively coupled by one of its poles to the channel areas over an air gap and by its other pole to a 10 counter-electrode having a reference potential, characterized in that a hydrophobic layers is arranged on the surface of the gas sensor between the gas sensitive layer and the channel area and/or a sensor electrode, which is electrically connected to a gate electrode arranged on the channel area.

2. A gas sensor as defined in claim 1, characterized in that it has an electrically conductive guard ring on its surface, which delimits the channel areas and/or the sensor electrode leading to the channel areas from the channel area and/or the sensor electrodes by means of a space, and further 20 characterized in that the hydrophobic layer is arranged in at least one area of the surface of the gas sensor located between the guard ring and the channel area and/or the sensor electrode.

3. A gas sensor as defined in claim 1, characterized in that the 25 hydrophobic layer extends continuously over the channel area and/or the sensor electrode.

4. A gas sensor as defined in claim 1, characterized in that the hydrophobic layer is separated from the channel area and/or the 30 sensor electrode and delimits the channel area and/or the sensor electrode preferably in a ring- or frame-like manner.

5. A gas sensor as defined in claim 1, characterized in that the static contact angle of the hydrophobic layer measured with water 5 and obtained on a planar surface is at least 70°, if necessary at least 90°, especially at least 105° and preferably at least 120°.

6. A gas sensor as defined in claim 1, characterized in that molecules of the hydrophobic layer are covalently bound to the surface 10 of an adjacent, preferably semi-conductive or electrically insulating layer of the gas sensor.

7. A gas sensor as defined in claim 1, characterized in that the hydrophobic layer contains at least one polymer.

8. A gas sensor as defined in claim 1, characterized in that the polymer is a fluoride and preferably a perfluoride polymer.

9. A gas sensor as defined in claim 1, characterized in 20 that the polymer is connected by an intermediate layer that is preferably in the form of a monolayer to an adjacent, preferably semi-conductive or electrically insulating layer of the gas sensor, and further characterized in that the intermediate layer has at least one reactive group anchored on the adjacent layer, and that the polymer is coupled preferably by means of a covalent bond to 25 the intermediate layer.

10. A gas sensor as defined in claim 1, characterized in that the hydrophobic layer has a surface profiling with projections and depressions.

11. A gas sensor as defined in claim 1, characterized in that the depressions are in the form of slots or grooves and preferably form a frame or a ring around the channel area and/or the sensor electrode.
